(19) United States
(12) Patent Application Publication
(10) Pub. No.: US 2025/0222525 A1
(43) Pub. Date: Jul. 10, 2025

(54) TURNING CUTTING INSERT WITH CORNER CUTTING PORTION HAVING REDUCED NOSE ANGLE AND TURNING TOOL

(71) Applicant: ISCAR, LTD., TEFEN (IL)

(72) Inventors: MEIR BAR HEN, NAHARIYA (IL); DANIEL HEN, NAHARIYA (IL)

(73) Assignee: ISCAR, LTD., TEFEN (IL)

(21) Appl. No.: 18/910,987

(22) Filed: Oct. 9, 2024

Related U.S. Application Data
(60) Provisional application No. 63/618,423, filed on Jan. 8, 2024.

(51) Int. Cl. B23B 27/00

(52) U.S. Cl. CPC B23B 27/005; B23B 2200/0495; B23B 2200/245; B23B 2200/28

(57) ABSTRACT

A cutting tool has an insert holder and a cutting insert releasably attached thereto. The cutting insert has an insert edge which includes two nose cutting edges and a convex corner cutting edge which extends therebetween. The two nose cutting edges form a nose angle. The insert edge also includes two mid-side edges which are located further from the corner cutting edge than the nose cutting edges. The two mid-side edges form a mid-side angle. The nose angle is less than the mid-side angle.

### RELATED APPLICATIONS

The present application claims priority to U.S. Provisional Patent Application No. 63/618,423 filed 2024 Jan. 8. The contents of the aforementioned application are incorporated by reference in their entirety.

### FIELD OF THE INVENTION

The subject matter of the present application relates to a cutting insert for a turning cutting tool, and in particular the nose angle of such a cutting insert.

### BACKGROUND OF THE INVENTION

Cutting inserts for turning metal cutting operations regularly have a corner cutting portion. The corner cutting portion has a nose angle. A large nose angle has a large cutting edge engagement and is robust but generally requires a greater amount of machine power and has a greater propensity to vibrate. A small nose angle has a smaller cutting edge engagement and is weaker, both of which might make it more vulnerable to the effects of heat.

Various cutting inserts for turning cutting operations are disclosed in EP 3153260 B1 and EP 3153261 B1.

It is an object of the present application to provide an improved cutting insert having a corner cutting portion that is robust but also consumes less machine power.

### SUMMARY OF THE INVENTION

In accordance with a first aspect of the subject matter of the present application there is provided a cutting insert, for turning metal cutting operations, having an insert central axis defining opposite upward and downward directions, the cutting insert comprising:
opposing insert upper and lower surfaces and an insert peripheral surface extending therebetween and about the insert central axis;
an insert edge formed at the intersection of the insert upper surface and the insert peripheral surface, the insert edge comprising two side edges and a convex corner edge extending therebetween, the two side edges comprising two mid-side edges spaced apart from the corner edge, each side edge having a respective one of the mid-side edges formed thereon;
a corner cutting portion which exhibits mirror symmetry with respect to a corner bisector plane which contains the insert central axis, the corner cutting portion comprising:
   a corner cutting edge formed from the corner edge; and
   two nose cutting edges and two narrowing edges formed on the two side edges, each side edge having a respective one of the nose cutting edges and a respective one of the narrowing edges formed thereon; wherein:
      each nose cutting edge extends from the corner cutting edge to a respective narrowing edge;
      each narrowing edge extending from a respective nose cutting edge towards a respective mid-side edge, each narrowing edge extending away from the corner bisector plane with increasing distance from the respective nose cutting edge; and
the two nose cutting edges form a nose angle and the two mid-side edges form a mid-side angle, the nose angle being less than the mid-side angle.

In accordance with a second aspect of the subject matter of the present application there is provided a turning cutting tool comprising:
an insert holder having a holder longitudinal axis defining opposite forward and rearward directions, the insert holder comprising an insert pocket located at a forward end thereof; and
a cutting insert, of the type described above, releasably retained in the insert pocket by a fastening member.

It is understood that the above-said is a summary, and that features described hereinafter may be applicable in any combination to the subject matter of the present application, for example, any of the following features may be applicable to the cutting insert or the turning cutting tool:

The corner cutting portion can further comprise two intermediate edges formed on the two side edges, each side edge having a respective one of the intermediate edges formed thereon. Each intermediate edge can extend between a respective narrowing edge and a respective mid-side edge. In a top view of the cutting insert, each intermediate edge can be co-linear with a respective mid-side edge.

The cutting insert has a median plane extending midway between the insert upper and lower surfaces. Each intermediate edge can comprise a near-corner intermediate edge and a far-corner intermediate edge, the far-corner intermediate edge being further from the corner cutting edge than the near-corner intermediate edge. The far-corner intermediate edge can extend away from the median plane with increasing distance from the near-corner intermediate edge.

The cutting insert has a median plane extending midway between the insert upper and lower surfaces. The two nose cutting edges can extend towards the median plane with increasing distance from the corner cutting edge.

The corner cutting edge and the two nose cutting edges can be located within an angular extent of the mid-side angle.

No part of the narrowing edge may be located closer to a mid-way point of the side edge upon which the narrowing edge is formed than to the corner cutting edge.

The nose cutting edge has a nose cutting edge length. The nose cutting edge length can be greater than or equal to 1.5 mm and less than or equal to 4.5 mm.

The insert peripheral surface can comprise two side surfaces and a convex corner surface extending therebetween, each side surface terminating at a respective one of the side edges and the corner surface terminating at the corner edge. The two side surfaces can comprise two mid-side surfaces spaced apart from the corner surface, each side surface having a respective one of the mid-side surfaces formed thereon. The corner cutting portion can further comprises a corner relief surface formed from the corner surface, two nose relief surfaces and two narrowing surfaces located on the two side surfaces, each side surface having a respective one of the nose relief surfaces and a respective one of the narrowing surfaces formed thereon. Each nose relief surface can extend from the corner relief surface to a respective narrowing surface. Each narrowing surface can extend between a respective nose relief surface and a respective mid-side surface, each narrowing surface extending away from the corner bisector plane with increasing distance from the respective nose relief surface.

The two mid-side surfaces can be oriented parallel to the insert central axis.

The corner relief surface and the two nose relief surfaces can all be oriented parallel to the insert central axis.

The cutting insert can comprise exactly three corner cutting portions and the insert edge can comprise exactly three side edges.

For any given corner cutting portion, the mid-side angle can be equal to 60° and the nose angle can be equal to 55°.

The cutting insert can exhibit N-fold rotational symmetry about the insert central axis.

The cutting insert has a median plane extending midway between the insert upper and lower surfaces. The cutting insert can exhibit mirror symmetry with respect to the median plane.

The convex corner cutting edge can be defined by a corner radius. The corner radius can fulfill the condition: 0.4 mm≤R≤2.0 mm.

The cutting insert can be pressed-to-size and no portion or surface thereof can be ground.

The two side edges comprise first and second side edges. The cutting tool has an approach angle defined by the nose cutting edge of the first side edge. The approach angle can fulfill the condition: 5°≤μ≤7°.

The cutting tool has a ramp down angle defined by the nose cutting edge of the second side edge. The ramp down angle can fulfill the condition: 23°≤θ≤25°.

The nose cutting edge of the first side edge can be oriented parallel to the holder longitudinal axis.

The insert lower surface can comprise a lower abutment surface. The insert pocket can comprise a pocket base surface and a pocket support surface oriented transversely thereto. The insert peripheral surface can comprise two side surfaces and a convex corner surface extending therebetween, each side surface terminating at a respective one of the side edges and the corner surface terminating at the corner edge. The two side surfaces can comprise two mid-side surfaces spaced apart from the corner surface, each side surface having a respective one of the mid-side surface formed thereon. The corner cutting portion can further comprise a corner relief surface formed from the corner surface, and two nose relief surfaces and two narrowing surfaces formed on the two side surfaces, each side surface having a respective one of the nose relief surfaces and a respective one of the narrowing surface formed thereon. Each nose relief surface can extend from the corner relief surface to a respective narrowing surface. Each narrowing surface can extend between a respective nose relief surface and a respective mid-side surface, each narrowing surface extending away from the corner bisector plane with increasing distance from the respective nose relief surface. The two mid-side surfaces can be oriented parallel to the insert central axis. The lower abutment surface can abut the pocket base surface and one of the mid-side surfaces can abut the pocket support surface.

The cutting insert can comprise exactly three corner cutting portions and the insert edge can comprise exactly three side edges. The exactly three corner cutting portions can comprise a forwardmost active corner cutting portion and two non-active corner cutting portions. The one of the mid-side surfaces that abuts the pocket support surface can be located between the two non-active corner cutting portions.

The two side edges comprise first and second side edges. Measured in a direction along the holder longitudinal axis, at the active corner cutting portion, the corner cutting edge and the nose cutting edge of the first side edge define a first cutting length. The first cutting length can be greater than or equal to 2 mm and less than or equal to 5 mm.

Measured in a direction along the holder longitudinal axis, at the active corner cutting portion, the corner cutting edge and the nose cutting edge of the second side edge at the active corner cutting portion define a second cutting length. The second cutting length can be greater than or equal to 1 mm and less than or equal to 2 mm.

The fastening member can be a clamping arm, releasably attached to the insert holder by a clamping screw. The pocket support surface can be located on the fastening member.

### BRIEF DESCRIPTION OF THE FIGURES

For a better understanding of the present application and to show how the same may be carried out in practice, reference will now be made to the accompanying drawings, in which:

FIG. 1 is a perspective view of a cutting insert, in accordance with a first embodiment of the present application;

FIG. 1A is a detail of FIG. 1, showing a corner cutting portion of the cutting insert;

FIG. 2 is a top view of the cutting insert in FIG. 1;

FIG. 2A is a detail of FIG. 2;

FIG. 3 is a side view of the cutting insert in FIG. 1;

FIG. 4 is second side view of the cutting insert shown in FIG. 1;

FIG. 5 is a cross section view taken along line V-V in FIG. 2;

FIG. 6 is a perspective view of the cutting insert, in accordance with a second embodiment of the present application;

FIG. 7 is a side view of the cutting insert in FIG. 6;

FIG. 8 is a view analogous to the view shown in FIG. 5, in accordance with the second embodiment of the present application;

FIG. 9 is a top view of a turning cutting tool;

FIG. 9A is a detail of FIG. 9, showing an active corner cutting portion; and

FIG. 10 is a side view of the turning cutting tool shown in FIG. 9.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

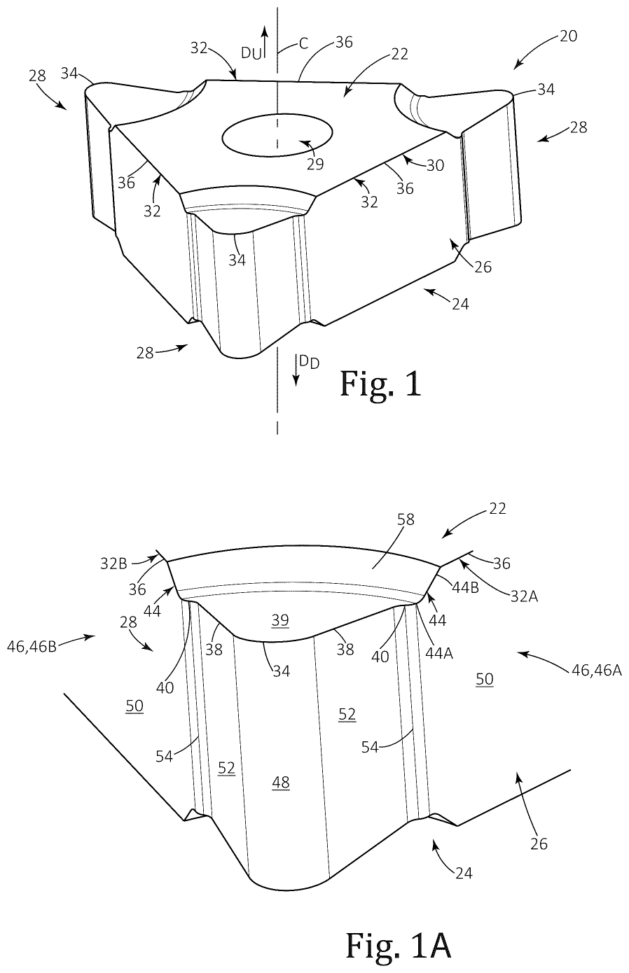

Attention is first drawn to FIG. 1, showing a cutting insert 20, in accordance with a first embodiment of the present application. The cutting insert 20 is typically made from cemented carbide and can, additionally or alternatively, be coated with a wear-resistant material. The cutting insert 20 is preferably pressed-to-size. Thus, the manufacture of the cutting insert 20 may not require any costly post manufacture process, such a grinding.

The cutting insert 20 includes opposing insert upper and lower surfaces 22, 24 and an insert peripheral surface 26 that extends between the insert upper and lower surfaces 22, 24. The insert peripheral surface 26 extends about an insert central axis C. The insert central axis C defines opposite upward and downward direction D_{U}, D_{D}. Generally speaking, the insert upper surface 22 faces in the upward direction D_{U} and the insert lower surface 24 faces in the downward direction D_{D}.

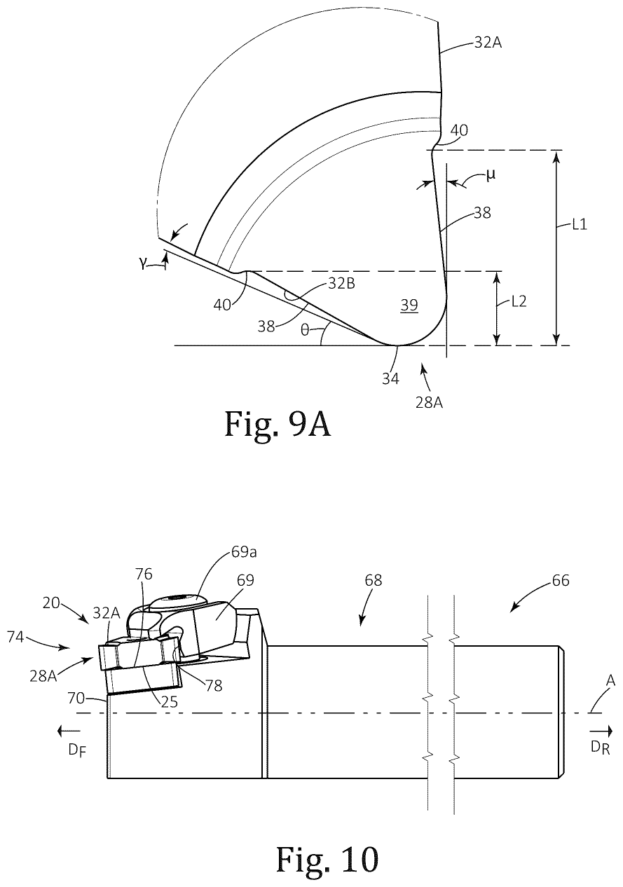

In accordance with some embodiments of the subject matter of the present application, the insert lower surface 24 can include a lower abutment surface 25, for abutting a corresponding surface in an insert pocket, as described later in the description. The lower abutment surface 25 can be planar and perpendicular to the insert central axis C. The cutting insert 20 can include a through hole 29 which opens out to the insert upper and lower surfaces 22, 24. The through hole 29 can be configured to receive an engagement pin 31 attached to the insert pocket (see FIG. 9).

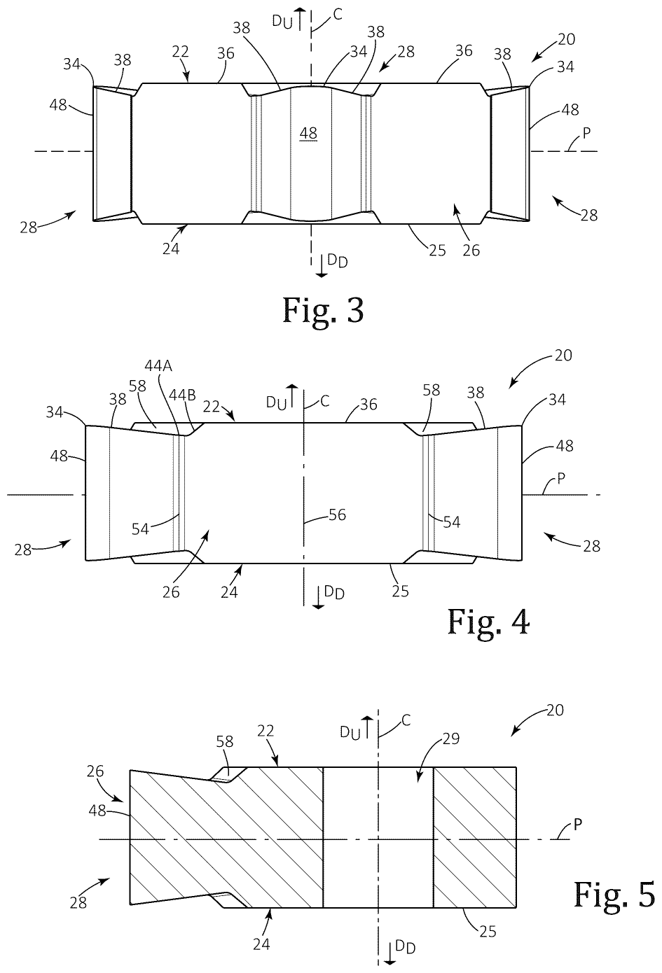

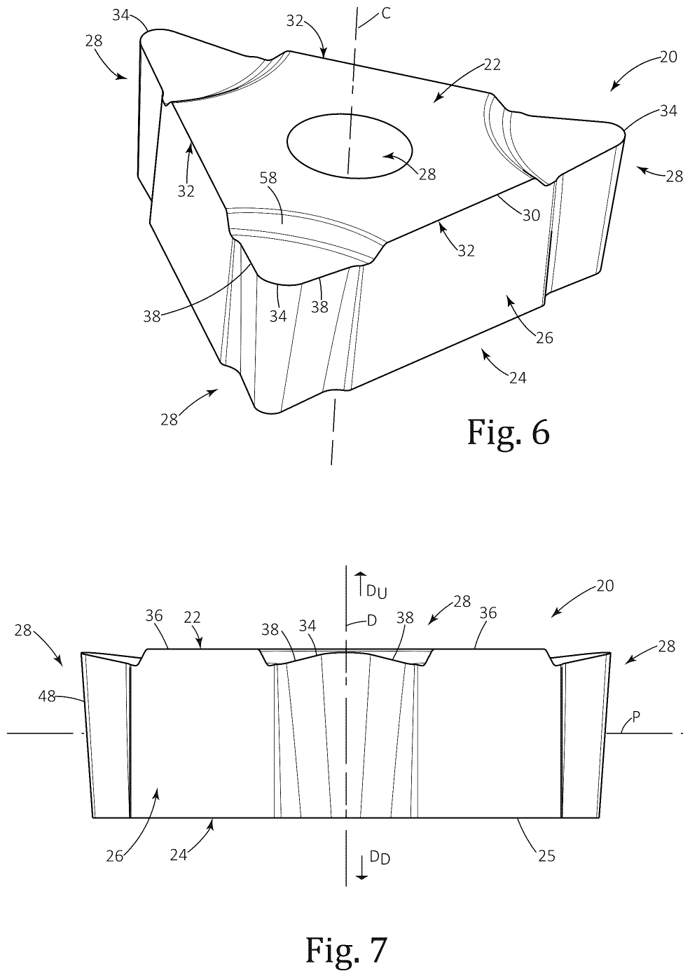

As seen in FIGS. 3 and 4, the cutting insert 20 has a median plane P which extends midway between the insert upper and lower surfaces 22, 24. In accordance with some embodiments of the subject matter of the present application, the median plane P can be perpendicular to the insert central axis C. In accordance with the first embodiment of the subject matter of the present application, the cutting insert 20 can exhibit mirror symmetry with respect to the median plane P. Thus, the cutting insert 20 can be double-sided (i.e., reversable). Alternatively, in accordance with a second embodiment of the subject matter of the present application, the cutting insert 20 may be single-sided. In accordance with some embodiments of the subject matter of the present application, the cutting insert 20 can exhibit N-fold rotational symmetry about the insert central axis C, where N is a positive integer.

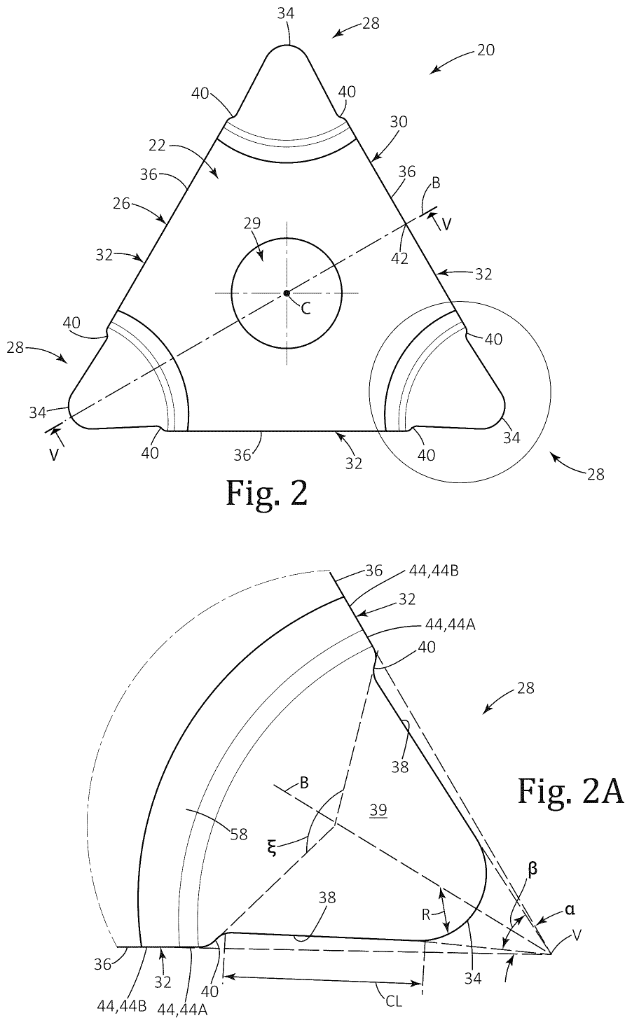

As seen in FIG. 2, the cutting insert 20 includes a corner cutting portion 28. The corner cutting portion 28 has a corner bisector plane B which contains the insert central axis C. The corner cutting portion 28 exhibits mirror symmetry with respect to the corner bisector plane B.

Reverting to FIG. 1A, the cutting insert 20 includes an insert edge 30 formed at the intersection of the insert upper surface 22 and the insert peripheral surface 26. The insert edge 30 includes two side edges 32A, 32B, namely a first and a second side edge 32A, 32B.

As seen in FIG. 2A, the insert edge 30 includes a convex corner edge 33. The first and a second side edge 32A, 32B are connected by the corner edge 33. Stated differently, the corner edge 33 extends between the two side edges 32A, 32B. In accordance with some embodiments of the subject matter of the present application, the convex corner edge 33 can be defined by a corner radius R. The corner radius R can fulfill the condition: 0.4 mm≤R≤2.0 mm. Preferably, the corner radius R can fulfill the condition: 0.8 mm≤R≤1.0 mm.

In this non-limiting example shown in the drawings, the cutting insert 20 includes exactly three corner cutting portions 28. Thus, the insert edge 30 includes exactly three corner edges 33 and includes exactly three side edges 32A, 32B, 32C, with the exactly three corner edges 33 and the exactly three side edges 32A, 32B, 32C alternating with each other about the insert central axis C. Thus, the cutting insert 20 can have a triangular basic shape. The exactly three corner cutting portions 28 can be identical. Likewise, the exactly three side edges 32A, 32B, 32C can be identical.

Referring to FIGS. 3 and 4, the two side edges 32A, 32B include two mid-side edges 36 which are spaced apart from the corner edge 33. Each side edge 32, 32A, 32B has a respective one of the mid-side edges 36 formed thereon. That is to say, the two mid-side edges 36 are located on different side edges 32A, 32B. Reverting to FIG. 2A, each mid-side edge 36 extends away from the corner bisector plane B with increasing distance from the corner edge 33. The two mid-side edges 36 converge towards each other in a direction towards the corner edge 33. The two mid-side edges 36 form (i.e., enclose) a mid-side angle α. The mid-side angle α is an internal angle. In accordance with some embodiments of the subject matter of the present application, the two mid-side edges 36 can be linear. In the configuration of the cutting insert 20 having exactly three corner cutting portions 28 (and exactly three side edges 32A, 32B, 32C), each mid-side edge 36 is located between two circumferentially adjacent corner cutting portions 28.

It should be appreciated that throughout the detailed description and claims, an “internal angle” refers to an angle between two surface components of a member surface as measured internal to the member, whereas an “external angle” refers to an angle between two surface components of a member surface as measured external to the member. It should also be appreciated that a top view of the cutting insert 20 is a view along the insert central axis C.

Referring again to FIG. 2A, the corner cutting portion 28 includes a corner cutting edge 34 formed from the corner edge 33. The corner cutting portion 28 includes two nose cutting edges 38 formed on the two side edges 32A, 32B. Each nose cutting edge 38 extends from the corner cutting edge 34. Thus, the two mid-side edges 36 are located further from the corner cutting edge 34 than the nose cutting edges 38. The corner cutting edge 34 and the two nose cutting edges 38 exhibit mirror symmetry with respect to the corner bisector plane B. Each side edge 32A, 32B has a respective one of the nose cutting edges 38 formed thereon. That is to say, the two nose cutting edges 38 are formed on different side edges 32A, 32B. Each nose cutting edge 38 extends away from the corner bisector plane B with increasing distance from the corner cutting edge 34. The two nose cutting edges 38 converge towards each other in a direction towards the corner cutting edge 34. The two nose cutting edges 38 form a nose angle β. The nose angle β is an internal angle. In accordance with some embodiments of the subject matter of the present application, the corner cutting edge 34 can be located within an angular extent of the mid-side angle α. The two nose cutting edges 38 can be linear. The two nose cutting edges 38 can extend tangentially from the corner cutting edge 34. The two nose cutting edges 38 can be located within the angular extent of the mid-side angle α. The nose angle β and the mid-size angle α can have the same angle vertex V. The angular extent of the nose angle β can be contained within the angular extent of the mid-side angle α. Referring to FIG. 4, the two nose cutting edges 38 can extend towards the median plane P with increasing distance from the corner cutting edge 34. That is to say, the two nose cutting edges 38 are sloped downwardly (i.e., in the downward direction D_{D}) in a direction away from the corner cutting edge 34.

As seen in FIG. 2A, the nose cutting edge 38 has first and second nose end points P1, P2 where the nose cutting edge 38 transitions into a narrowing edge 40 (described below) and the corner cutting edge 34, respectively. The nose cutting edge 38 has a nose cutting edge length CL measured between the two nose edge end points P1, P2. In this non-limiting example shown in the drawings, the first and second nose end points P1, P2 are the end points of a straight line. The nose cutting edge length CL can be greater than or equal to 1.5 mm and less than or equal to 4.5 mm. In particular, the nose cutting edge length CL can be greater than or equal to 2 mm and less than or equal to 4 mm.

The insert upper surface 22 includes a rake surface 39 extending between (i.e., connecting) the two nose cutting edges 38 and the corner cutting edge 34. The rake surface 39 can have a chip breaker (not shown) for forming manageable chips. In the configuration where nose cutting edges are 38 sloped downwardly (i.e., in the downward direction D_{D}) in a direction away from the corner cutting edge 34, the rake surface 39 also slopes downwardly in a direction away from the corner cutting edge 34.

The nose angle β is less than the mid-side angle α. By virtue of such a configuration, less machine power is required than a configuration in which the nose angle β is equal to or greater than the mid-side angle α (while sufficient overall strength of the cutting insert 20 is maintained). In accordance with some embodiments of the subject matter of the present application, the nose angle β can be less than the mid-side angle α by no more than 10°. The mid-side angle α can be equal to 60° and the nose angle β can be equal to 55°. This may be particularly advantageous in the configuration of the cutting insert 20 having exactly three corner cutting portions 28 (suitable for cutting), since the carbide turning inserts having a 55° nose angle are rhombic shaped (‘D’ geometry under the designation for ISO standard turning insert shapes—see https://www.secotools.com/article/120341?language=en) and thus have only two corner cutting portions suitable for cutting.

As seen in FIGS. 2 and 2A, the corner cutting portion 28 includes two narrowing edges 40 formed on the two side edges 32A, 32B. Each side edge 32A, 32B has a respective one of the narrowing edges 40 formed thereon. That is to say, the two narrowing edges 40 are formed on different side edges 32A, 32B. Each narrowing edge 40 extends from a respective nose cutting edge 38 towards a respective mid-side edge 36. Each narrowing edge 40 extends away from the corner bisector plane B with increasing distance from the respective nose cutting edge 38 (from which it extends). Or stated differently, each narrowing edge 40 extends toward the corner bisector plane B with increasing distance from a respective mid-side edge 36. The two narrowing edges 40 converge towards each other in a direction towards the corner cutting edge 34. The two narrowing edges 40 form a narrowing angle. The narrowing angle ε is an internal angle. The narrowing angle & can be an obtuse angle. The narrowing angle ε can be greater than the mid-side angle α and the nose angle β. That is to say, each narrowing edge 40 extends away from the corner bisector plane B with increasing distance from the corner cutting edge 34 to a greater extent than the than the mid-side edge 36 and the nose cutting edge 38. As seen best in FIG. 2, in accordance with some embodiments of the subject matter of the present application, each narrowing edge 40 can be located closer to the corner cutting edge 34 than to a mid-way point 42 of the side edge 32A, 32B upon which the narrowing edge 40 is formed. Preferably, no part of the narrowing edge 40 is located closer to the mid-way point 42 than to the corner cutting edge 34. In the configuration of the cutting insert 20 having exactly three corner cutting portions 28, the mid-way point 42 may lie (i.e., be contained) in the corner bisector plane B of a circumferentially adjacent corner cutting portion 28.

From the foregoing it is understood, that on each side of the corner cutting edge 34, the nose cutting edge 38 extends from the corner cutting edge 34 to the narrowing edge 40.

Referring to FIGS. 1A and 2A, in accordance with some embodiments of the subject matter of the present application, the corner cutting portion 28 can include two intermediate edges 44 formed on the two side edges 32A, 32B. Each side edge 32A, 32B has a respective one of the intermediate edges 44 formed thereon. That is to say, the two intermediate edges 44 are formed on different side edges 32A, 32B. Each intermediate edge 44 can extend between a respective narrowing edge 40 and a respective mid-side edge 36. In a top view of the cutting insert 20, along the insert central axis C (see FIG. 2A), each intermediate edge 44 can be co-linear with a respective mid-side edge 36.

Referring to FIG. 4, in accordance with some embodiments of the subject matter of the present application, each intermediate edge 44 can include a near-corner intermediate edge 44A and a far-corner intermediate edge 44B. The far-corner intermediate edge 44B is further from the corner cutting edge 34 than the near-corner intermediate edge 44A. The near-corner intermediate edge 44A extends towards the median plane P with increasing distance from a respective narrowing edge 40. The far-corner intermediate edge 44B extends away from the median plane P with increasing distance from near-corner intermediate edge 44A.

It is understood that for the double-sided cutting insert 20, the insert lower surface 24 can have an identical configuration as the insert upper surface 22 (including its intersection with the insert peripheral surface 26), and thus the description of the insert lower surface 24 is omitted.

Reverting to FIGS. 1 and 1A, the insert peripheral surface 26 includes two side surfaces 46A, 46B, namely a first side surface 46A and a second side surface 46B. In accordance with some embodiments of the subject matter of the present application, each side surface 46A, 46B can terminate at (i.e., intersect) a respective one of the side edges 32A, 32B.

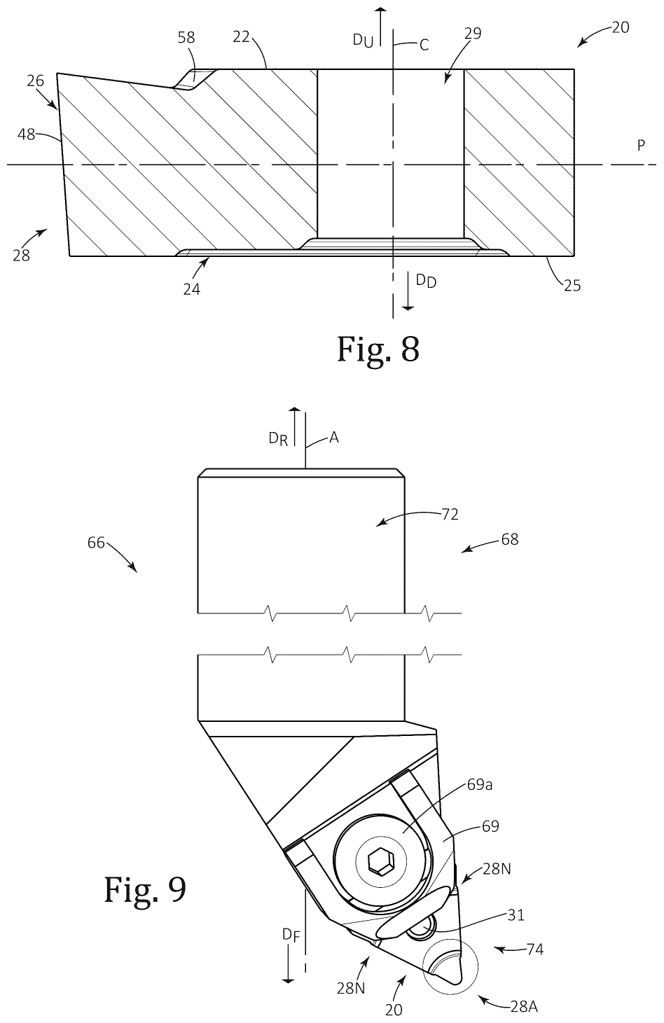

The insert peripheral surface 26 includes a convex corner surface 47 which extends between the two side surfaces 46A, 46B. In accordance with some embodiments of the subject matter of the present application, the corner surface 47 can terminate at the corner edge 33. Referring to FIG. 3-5, in accordance with the first embodiment of the subject matter of the present application, the corner surface 47 can be oriented parallel to the insert central axis C. Referring to FIGS. 7 and 8, in accordance with the second embodiment of the subject matter of the present application (i.e., the embodiments relating the single-sided cutting insert 22), the corner surface 47 can be sloped towards the insert central axis C with increasing distance from the insert upper surface 22.

In the configuration of the cutting insert 20 having exactly three corner cutting portions 28, the insert peripheral surface 26 includes exactly three side surfaces 46A, 46B, 46C and exactly three corner surfaces 47, the exactly three side surfaces 46A, 46B, 46C and exactly three corner surfaces 47 alternating with each other about the insert central axis C. The exactly three side surfaces 46A, 46B, 46C can be identical.

In accordance with some embodiments of the subject matter of the present application, the two side surfaces 46A, 46B can include two mid-side surfaces 50 which are spaced apart from the corner surface 47. Each side surface 46A, 46B has a respective one mid-side of the surfaces 50 formed thereon. That is to say, the two mid-side surfaces 50 are located on different side surfaces 46A, 46B. Each mid-side surface 50 can terminate at a respective mid-side edge 36 and optionally a respective one of the intermediate edges 44. The two mid-side surface 50 can be planar. The two mid-side surfaces 50 can be oriented parallel to the insert central axis C.

In accordance with some embodiments of the subject matter of the present application, the corner cutting portion 28 can include a corner relief surface 48 formed from the corner surface 47. The corner relief surface 48 serves as a relief surface. The corner cutting portion 28 can include two nose relief surfaces 52 formed on the two side surfaces 46A, 46B. Each side surface 46A, 46B has a respective one of the nose relief surfaces 52 formed thereon. That is to say, the two nose relief surfaces 52 are formed on different side surfaces 46A, 46B. The two nose relief surfaces 52 serve as relief surfaces. Each nose relief surface 52 can extend from the corner relief surface 48. Each nose relief surface 52 can terminate at a respective nose cutting edge 38. In accordance with the first embodiment of the subject matter of the present application, the two nose relief surfaces 52 can both be oriented parallel to the insert central axis C. In accordance with a second embodiment of the subject matter of the present application (i.e., the embodiments relating single-sided cutting insert 22), the two nose relief surfaces 52 can slope towards the corner bisector plane B with increasing distance from the insert upper surface 22.

In accordance with some embodiments of the subject matter of the present application, the corner cutting portion 28 can include two narrowing surfaces 54 formed on the two side surfaces 46A, 46B. Each side surface 46A, 46B has a respective one of the narrowing surfaces 54 formed thereon, respectively. That is to say, the two narrowing surfaces 54 are formed on different side surfaces 46A, 46B. Each nose relief surface 52 can extend to a respective narrowing surface 54. Each narrowing surface 54 can extend from a respective nose relief surface 52 to a respective mid-side surface 50. The narrowing surface 54 can extend away from the corner bisector plane B with increasing distance from the respective nose relief surface 52. Each narrowing surface 54 can terminate at a respective narrowing edge 40. Reverting to FIG. 4, each narrowing surface 54 can be located closer to the corner relief surface 48 than to a mid-way line 56 of the respective side surface 46A, 46B upon which the narrowing surface 54 is formed. Preferably, no part of the narrowing surface 54 can be located closer to the mid-way line 56 than to the corner relief surface 48. Reverting to FIG. 2, in the configuration of the cutting insert 20 having exactly three corner cutting portions 28, the mid-way line 56 can be contained in the corner bisector plane B of a circumferentially adjacent corner cutting portion 28.

From the foregoing it is understood, that on each side of the corner relief surface 48, the nose relief surface 52 can extend from the corner relief surface 48 to the narrowing surface 54 and the narrowing surface 54 can extend from the nose relief surface 52 to the mid-side surface 50.

In accordance with some embodiments of the subject matter of the present application, the insert upper surface 22 can include a deflecting surface 58 extending between (i.e., connecting) the side edges 32A, 32B. The deflecting surface 58 can be spaced apart from the corner cutting edge 34 and the two nose cutting edges 38. In particular, the deflecting surface 58 can extend between the two intermediate edges 44. The deflecting surface 58 can intersect the rake surface 39. The deflecting surface 58 can extend away from the median plane P with increasing distance from the rake surface 39.

Referring to FIGS. 9-10, a second aspect of the present application relates to a non-rotary cutting tool 66. For example, the cutting tool 66 can be designed for turning cutting operations as opposed to milling or drilling cutting operation. The cutting tool 66 includes an insert holder 68 and the cutting insert 20 releasably attached thereto by a fastening member 69.

The insert holder 68 is elongated along a holder longitudinal axis A. The holder longitudinal axis A defines opposite forward and rearward directions D_{F}, D_{R}. It should be appreciated that use of the terms “forward” and “rearward” throughout the description and claims refer to a relative position in a direction of the holder longitudinal axis A towards the left and right, respectively, in FIG. 10.

The insert holder 68 includes a holder end surface 70 and a holder peripheral surface 72 which extends about the holder longitudinal axis A. The holder end surface 70 is bounded by the holder peripheral surface 72.

The insert holder 68 includes an insert pocket 74 located at a forward end of thereof. The insert pocket 74 is recessed in the holder peripheral surface 72 and opens out to the holder end surface 70. The insert pocket 74 can be positioned and oriented so that the cutting tool 66 is suitable for left hand turning or right hand turning. The insert pocket 74 can include a pocket base surface 76 and a pocket support surface 78 oriented transversely thereto. In accordance with some embodiments of the subject matter of the present application (e.g., when the fastening member 69 is a clamping arm as discussed below), the pocket support surface 78 can be located on the fastening member 69. The pocket support surface 78 can be oriented perpendicular to pocket base surface 76. The pocket base surface 76 can be formed on a shim releasably attached to the insert pocket 74 (see FIG. 10).

Referring to FIGS. 9-9A, in accordance with some embodiments of the subject matter of the present application, the cutting insert 20, can be releasably retained in the insert pocket 74 by the fastening member 69. The fastening member 69 can be a clamping arm, releasably attached to the insert holder 68 by a clamping screw 69a, which clamps the clamping insert 20 on a portion of the insert upper surface 26. Thus, it is noted that the through hole 29 may not be configured for a clamping screw. In the configuration of the cutting insert 20 having exactly three corner cutting portions, the exactly three corner cutting portions 28 include a forwardmost active corner cutting portion 28A and two non-active corner cutting portions 28B. For the active corner cutting portion 28A, the first side edge 32A is the radially outward from the second side edge 32B.

Referring to FIG. 10, in accordance with some embodiments of the subject matter of the present application, the lower abutment surface 25 can abut the pocket base surface 76. One of the mid-side surfaces 50 can abut the pocket support surface 78. In the configuration of the cutting insert 20 with exactly three corner cutting portions 28, the one of the mid-side surfaces 50 that abuts the pocket support surface 78 is located between the two non-active corner cutting portions 28B.

The nose cutting edge 38 of the first side edge 32A perform front turning cutting operations. Referring to FIG. 9a, the cutting tool 66 has an approach angle μ defined by the nose cutting edge 38 of the first side edge 32A. In accordance with some embodiments of the subject matter of the present application, the approach angle μ can fulfill the condition: 5°≤μ≤7°.

Referring to FIG. 9A, the nose cutting edge 38 of the second side edge 32B is suitable to perform ramp down cutting operations. In particular, the nose cutting edge 38 of the second side edge 32B is suitable to perform ramp down cutting operations if the nose relief surface 52 which serves as the relief surface is configured to form a positive relief angle when seated in the insert pocket 74. The cutting tool 66 has a ramp down angle θ defined by the nose cutting edge 38 of the second side edge 32B and a ramp down clearance angle γ (which may maintain or facilitate maintaining clearance from the workpiece when cutting). The ramp down angle θ can fulfill the condition: 23°≤θ≤25° (assuming the ramp down clearance angle γ is 0.13°). In the configuration of the cutting insert 20 having exactly three corner cutting portions 28, the ramp down angle θ can be exactly 24°. It is noted that the narrowing surface 40 effects the ramp down angle θ. It is further noted that the nose cutting edge 38 of the second side edge 32B can perform back turning cutting operations in the single sided configuration of the cutting insert 20 (i.e., when the cutting tool 66 is moved in the back turning feed direction BT).

Measured in a direction perpendicular to the workpiece (e.g. along the holder longitudinal axis A), for the active corner cutting portion 28A, the corner cutting edge 34 and the nose cutting edge 38 of the first side edge 32A define a first cutting length L1, which defines a maximum depth of cut. The depth of cut is dependant on the angular position of insert with regard to the workpiece. The depth of cut can be limited by the narrowing edge 40, which is not a cutting edge. For example, in accordance with some embodiments of the subject matter of the present application, the first cutting length L1 can be greater than or equal to 2 mm and less than or equal to 5 mm. Measured in same direction, the corner cutting edge 34 and the nose cutting edge 38 of the second side edge 32B define a second cutting length L2. The second cutting length L2 can be greater than or equal to 1 mm and less than or equal to 2 mm.

In accordance with some embodiments of the subject matter of the present application, the nose cutting edge 38 of the first side edge 32A can be oriented parallel to the holder longitudinal axis A.

It is understood that for the single-sided cutting insert 20, the relief angle formed by the relief surfaces can be non-zero (i.e., the cutting insert 20 is a positive cutting insert). Alternatively, for the double-sided cutting insert 20, the relief angle formed by the relief surfaces can be zero (i.e., the cutting insert 20 is a negative cutting insert).

Although the subject matter of the present application has been described to a certain degree of particularity, it should be understood that various alterations and modifications could be made without departing from the spirit or scope of the invention as hereinafter claimed.

What is claimed is:

1. A cutting insert (20), for turning metal cutting operations, having an insert central axis (C) defining opposite upward and downward directions (D_{U}, D_{D}), the cutting insert (20) comprising:
opposing insert upper and lower surfaces (22, 24) and an insert peripheral surface (26) extending therebetween and about the insert central axis (C);
an insert edge (30) formed at the intersection of the insert upper surface (22) and the insert peripheral surface (26), the insert edge (30) comprising two side edges (32A, 32B) and a convex corner edge (33) extending therebetween, the two side edges (32A, 32B) comprising two mid-side edges (36) spaced apart from the corner edge (33), each side edge (32A, 32B) having a respective one of the mid-side edges (36) formed thereon;
a corner cutting portion (28) which exhibits mirror symmetry with respect to a corner bisector plane (B) which contains the insert central axis (C), the corner cutting portion (28) comprising:
a corner cutting edge (34) formed from the corner edge (33); and
two nose cutting edges (38) and two narrowing edges (40) formed on the two side edges (32A, 32B), each side edge (32A, 32B) having a respective one of the nose cutting edges (38) and a respective one of the narrowing edges (40) formed thereon; wherein:
each nose cutting edge (38) extends from the corner cutting edge (34) to a respective narrowing edge (40);
each narrowing edge (40) extending from a respective nose cutting edge (38) towards a respective mid-side edge (36), each narrowing edge (40) extending away from the corner bisector plane (B) with increasing distance from the respective nose cutting edge (38); and
the two nose cutting edges (38) form a nose angle (β) and the two mid-side edges (36) form a mid-side angle (α), the nose angle (β) being less than the mid-side angle (α).

2. The cutting insert (20) according to claim 1, wherein:
the corner cutting portion (28) further comprises two intermediate edges (44) formed on the two side edges (32A, 32B), each side edge (32A, 32B) having a respective one of the intermediate edges (44) formed thereon;
each intermediate edge (44) extends between a respective narrowing edge (40) and a respective mid-side edge (36); and
in a top view of the cutting insert (20), each intermediate edge (44) is co-linear with a respective mid-side edge (36).

3. The cutting insert (20) according to claim 2, wherein:
the cutting insert (20) has a median plane (P) extending midway between the insert upper and lower surfaces (22, 24);
each intermediate edge (44) comprises a near-corner intermediate edge (44A) and a far-corner intermediate edge (44B), the far-corner intermediate edge (44B) being further from the corner cutting edge (34) than the near-corner intermediate edge (44A); and
the far-corner intermediate edge (44B) extends away from the median plane (P) with increasing distance from the near-corner intermediate edge (44A).

4. The cutting insert (20) according to claim 1, wherein:
the cutting insert (20) has a median plane (P) extending midway between the insert upper and lower surfaces (22, 24); and
the two nose cutting edges (38) extend towards the median plane (P) with increasing distance from the corner cutting edge (34).

5. The cutting insert (20) according to claim 1, wherein:
the corner cutting edge (34) and the two nose cutting edges (38) are located within an angular extent of the mid-side angle (α).

6. The cutting insert (20) according to claim 1, wherein:
no part of the narrowing edge (40) is located closer to a mid-way point (42) of the side edge (32A, 32B) upon which the narrowing edge (40) is formed than to the corner cutting edge (34).

7. The cutting insert (20) according to claim 1, wherein:
the nose cutting edge (38) has a nose cutting edge length (CL);
the nose cutting edge length (CL) is greater than or equal to 1.5 mm and less than or equal to 4.5 mm.

8. The cutting insert (22) according to claim 1, wherein:
the insert peripheral surface (26) comprises two side surfaces (46A, 46B) and a convex corner surface (47) extending therebetween, each side surface (46A, 46B) terminating at a respective one of the side edges (32A, 32B) and the corner surface (47) terminating at the corner edge (33);
the two side surfaces (46A, 46B) comprise two mid-side surfaces (50) spaced apart from the corner surface (47), each side surface (46A, 46B) having a respective one of the mid-side surfaces (50) formed thereon;
the corner cutting portion (28) further comprises:
a corner relief surface (48) formed from the corner surface (47); and
two nose relief surfaces (52) and two narrowing surfaces (54) located on the two side surfaces (46A, 46B), each side surface (46A, 46B) having a respective one of the nose relief surfaces (52) and a respective one of the narrowing surfaces (54) formed thereon; wherein:
each nose relief surface (52) extends from the corner relief surface (48) to a respective narrowing surface (54); and
each narrowing surface (54) extends between a respective nose relief surface (52) and a respective mid-side surface (50), each narrowing surface (54) extending away from the corner bisector plane (B) with increasing distance from the respective nose relief surface (52).

9. The cutting insert (20) according to claim 8, wherein:
the two mid-side surfaces (50) are oriented parallel to the insert central axis (C).

10. The cutting insert (20) according to claim 9, wherein:
the corner relief surface (48) and the two nose relief surfaces (52) are all oriented parallel to the insert central axis (C).

11. The cutting insert (20) according to claim 1, wherein:
the cutting insert (20) comprises exactly three corner cutting portions (28) and the insert edge (30) comprises exactly three side edges (32A, 32B, 32C).

12. The cutting insert (20) according to claim 1, wherein:
for any given corner cutting portion (28):
the mid-side angle (α) is equal to 60°; and
the nose angle (β) is equal to 55°.

13. The cutting insert (20) according to claim 1, wherein:
the cutting insert (20) exhibits N-fold rotational symmetry about the insert central axis (C).

14. The cutting insert (20) according to claim 1, wherein:
the cutting insert (20) has a median plane (P) extending midway between the insert upper and lower surfaces (22, 24); and
the cutting insert (20) exhibits mirror symmetry with respect to the median plane (P).

15. The cutting insert (20) according to claim 1, wherein:
the convex corner cutting edge (34) is defined by a corner radius (R); and
the corner radius (R) fulfills the condition: 0.4 mm≤R≤2.0 mm.

16. The cutting insert (20) according to claim 1, wherein:
the cutting insert (20) is pressed-to-size and no portion or surface thereof is ground.

17. A turning cutting tool (66) comprising:
an insert holder (68) having a holder longitudinal axis (A) defining opposite forward and rearward directions (D_{F}, D_{R}), the insert holder (68) comprising an insert pocket (74) located at a forward end thereof; and
a cutting insert (20), according to claim 1, releasably retained in the insert pocket (74) by a fastening member (69).

18. The cutting tool (66) according to claim 17, wherein:
the two side edges (32A, 32B) comprise first and second side edges (32A, 32B);
the cutting tool (66) has an approach angle (u) defined by the nose cutting edge (38) of the first side edge (32A); and
the approach angle (μ) fulfills the condition: 5°≤μ≤7°.

19. The cutting tool (66) according to claim 17, wherein:
the cutting tool (66) has a ramp down angle (θ) defined by the nose cutting edge (38) of the second side edge (32B); and
the ramp down angle (θ) fulfills the condition: 23°≤θ≤25°.

20. The cutting tool (66) according to claim 17, wherein:
the nose cutting edge (38) of the first side edge (32A) is oriented parallel to the holder longitudinal axis (A).

21. The cutting tool (66) according to claim 17, wherein:
the insert lower surface (24) comprises a lower abutment surface (25);
the insert pocket (74) comprises a pocket base surface (76) and a pocket support surface (78) oriented transversely thereto;
the insert peripheral surface (26) comprises two side surfaces (46A, 46B) and a convex corner surface (47) extending therebetween, each side surface (46A, 46B) terminating at a respective one of the side edges (32A, 32B) and the corner surface (47) terminating at the corner edge (33); and
the two side surfaces (46A, 46B) comprise two mid-side surfaces (50) spaced apart from the corner surface (47), each side surface (46A, 46B) having a respective one of the mid-side surface (50) formed thereon;
the corner cutting portion (28) further comprises:
a corner relief surface (48) formed from the corner surface (47); and
two nose relief surfaces (52) and two narrowing surfaces (54) formed on the two side surfaces (46A, 46B), each side surface (46A, 46B) having a respective one of the nose relief surfaces (52) and a respective one of the narrowing surface (54) formed thereon; wherein:
each nose relief surface (52) extends from the corner relief surface (48) to a respective narrowing surface (54);
each narrowing surface (54) extends between a respective nose relief surface (52) and a respective mid-side surface (50), each narrowing surface (54) extending away from the corner bisector plane (B) with increasing distance from the respective nose relief surface (52);
the two mid-side surfaces (50) are oriented parallel to the insert central axis (C);
the lower abutment surface (25) abuts the pocket base surface (76); and
one of the mid-side surfaces (50) abuts the pocket support surface (78).

22. The cutting tool (66) according to claim 21, wherein:
the cutting insert (20) comprises exactly three corner cutting portions (28) and the insert edge (30) comprises exactly three side edges (32A, 32B, 32C);
the exactly three corner cutting portions (28) comprise a forwardmost active corner cutting portion (28A) and two non-active corner cutting portions (28B); and
the one of the mid-side surfaces (50) that abuts the pocket support surface (78) is located between the two non-active corner cutting portions (28B).

23. The cutting insert (20) according to claim 22, wherein:
the two side edges (32A, 32B) comprise first and second side edges (32A, 32B);
measured in a direction along the holder longitudinal axis (A), at the active corner cutting portion (28A), the corner cutting edge (34) and the nose cutting edge (38) of the first side edge (32A) define a first cutting length (L1); and
the first cutting length (L1) is greater than or equal to 2 mm and less than or equal to 5 mm.

24. The cutting insert (20) according to claim 23, wherein:
measured in a direction along the holder longitudinal axis (A), at the active corner cutting portion (28A), the corner cutting edge (34) and the nose cutting edge (38) of the second side edge (32B) at the active corner cutting portion (28A) define a second cutting length (L2); and
the second cutting length (L2) is greater than or equal to 1 mm and less than or equal to 2 mm.

25. The cutting tool (66) according to claim 17, wherein:
the fastening member (69) is a clamping arm, releasably attached to the insert holder by a clamping screw (69a);
the pocket support surface (78) is located on the fastening member (69).
